(19) United States
(12) Patent Application Publication
(10) Pub. No.: US 2026/0054522 A1
(43) Pub. Date: Feb. 26, 2026

(54) SYSTEM FOR MOUNTING AND RELEASING A WHEEL TO AND FROM A WHEEL SUPPORT

(71) Applicant: WHEEL.ME AS, Oslo (NO)

(72) Inventors: Andreas Blom-Bakke, Asker (NO); Rolf Libakken, Holter (NO)

(73) Assignee: WHEEL.ME AS, Oslo (NO)

(21) Appl. No.: 19/105,316

(22) PCT Filed: Aug. 24, 2023
(86) PCT No.: PCT/EP2023/073249

§ 371 Date: Feb. 20, 2025

(30) Foreign Application Priority Data
Aug. 24, 2022 (NO) 20220905

(51) Int. Cl. B60B 29/00; B60B 19/00

(52) U.S. Cl. CPC B60B 29/001; B60B 19/003; B60B 2900/112; B60B 2900/541

(57) ABSTRACT

The invention describes a system for locking and releasing a wheel (1) to and from a wheel support (2). The system comprises an interlocking mechanism (3) comprising a guiding slot (4) on the wheel support (2), and a guided structure (5), positioned on a stationary wheel section (6) of the wheel (1), mating with the guiding slot (4). The system further comprise a U-shaped locking tool (7) comprising two lever arms (8a, b) joined by a gripping bridge (9) at one end, and having an arm pivot structure (10) interacting with a wheel pivot structure (11) positioned on the stationary wheel section (6). The locking tool further comprises a pushing arm (13) interacting with a support slot (16) in the wheel support (2) for pushing the guided structure (5) into the guiding slot (4) when mounting the wheel, and for pushing the guided structure (5) a first distance (D1) out of the guiding slot (4) when releasing the wheel.

### TECHNICAL FIELD

The present invention concerns a system for mounting and releasing a wheel to and from a wheel frame or wheel support. The wheel and wheel support may be incorporated into a remotely controlled rolling device and may be arranged for automatically moving a group of devices according to pre-set scenarios.

The invention is in particular suitable for mecanum wheels allowing easy access for service of the mecanum wheel and rapid exchange of the wheel moving all kind of devices that is to be moved between different locations both indoors and outdoors, where the movement is to occur along a surface, for instance a floor, the ground or any other surface suitable for outdoor use.

### BACKGROUND

There are a number of circumstances where there is a need for moving various devices, for instance furniture, that may be provided with wheels or roller elements for facilitating the movement of devices from one location to another, for instance for regrouping devices or moving a device to get access to the space the device occupies or to provide access to the device itself. Use of rolling devices in warehouses and in production facilities is also a growing field.

The applicant has previously developed a rolling device capable of being integrated in devices, such as a piece of furniture, a movable wall, robots etc., for moving the device along a surface. The rolling device facilitates the moving of an object and can be used by everyone regardless of physical condition and capacity to lift different devices in which the rolling device is integrated. This device is described in Norwegian U.S. Pat. No. 316,760 B1.

The rolling device described in NO 316760 B1 of the applicant, comprises a cylindrical sleeve device for mounting in, for example, the leg of a piece of furniture, and a piston that is movably arranged in the cylindrical sleeve device. A ball-shaped or spherical wheel is arranged in the piston. The piston is movable, with the aid of a click system comprising a spring, between an upper position and a lower position. When the piston is in the lower position, the piece of furniture can be rolled across the floor it is standing on, whilst when the piston is in the upper position, the wheel is inside the cylindrical sleeve device and the leg of the piece of furniture, in which the rolling device is arranged, thus stands on the floor. The piece of furniture thus stands in the desired position without rolling inadvertently across the floor when small forces are applied to the piece of furniture. The solution is completely mechanical.

The applicant has further developed the concept and provided a rolling device with an automatic actuator system for moving a piston with a rolling element between an upper and lower position. This concept is disclosed in EP 3102429. The upper position is a passive stationary position where the wheel element is retracted in the rolling device, and the lower position is an active position for moving the rolling device along a surface. The actuator can be wirelessly controlled.

In a further version as described in WO 2018138320, the applicant has evolved the concept of the rolling device further. WO 2018138320 presents a rolling device for arrangement for autonomously moving a device from a first position to a second position along a surface. The rolling device controls the movements of a rolling element according to position acquisitions and given position and movement instructions. The rolling element may have a set or fixed vertical position relative to the rolling device or may be arranged for displacement between a retracted position where the wheel element is prevented from moving along a surface and an extended position where the wheel element is prepared for movement along the surface, as described in EP 3102429 and NO 316760 B1.

US 2005/015928 discloses an apparatus for attaching a wheeled element, such as a caster, comprising a caster bracket with means for engaging the caster plate of a caster. The caster is affixed to the caster plate and is then engaged with the caster bracket. The caster bracket is preferably flanged for slidably receiving the caster plate which is positively held in place with the aid of a flexible locking member affixed to the caster bracket. The flexible member is operatively arranged to substantially immobilize the caster plate when the member engages a surface of a slot in the caster plate. The flexible locking member further comprises a tab extension operatively arranged to allow disengagement of the caster safely by direct hand/finger engagement without requiring tools.

Mecanum wheels have been in use for a number of decades and are widely used for robotic movement. Mecanum wheels have a configuration allowing movement in any direction, and it is a conventional wheel with a series of rollers attached to its circumference. These rollers may typically each have an axis of rotation at 45° to the plane of the wheel and at 45° to a line through the centre of the roller parallel to the axis of rotation of the wheel but may of course also be arranged with axis of rotation having other inclinations than 45°. The angular position of the rollers in a mecanum wheel will cause some dragging of the roller surface along the floor/ground causing increased wear of the roller surface as compared to an ordinary wheel. Also, the increased number of moving parts in a mecanum wheel indicates that service is needed more often than for ordinary wheels.

The object of the present invention is therefore to provide a simple and reliable system for mounting, releasing and remounting of a wheel positioned in a wheel support. It is further an object of the invention to provide a solution that minimizes the costs for replacing the wheel, and also makes it possible for the customer or user of the wheel and wheel support to replace the wheel, without the expertise of the skilled mechanic.

### SUMMARY OF THE INVENTION

The invention describes a system for locking and releasing a wheel to and from a wheel support. The system comprises an interlocking mechanism comprising a guiding slot, with a centerline S, on the wheel support, and a guided structure positioned on a stationary wheel section of the wheel, configured for mating with the guiding slot. The system further comprises a locking tool comprising two lever arms joined by a gripping bridge at one end. At the other end each lever arm comprises an arm pivot structure interacting with a wheel pivot structure positioned on the stationary wheel section below the guided structure. The locking tool further comprises a pushing arm comprising a lower pushing arm surface interacting with a lower slot surface in a support slot in the wheel support for pushing the guided structure into the guiding slot. The pushing arm further comprises an upper pushing arm surface interacting with an upper slot surface in the support slot for pushing the guided structure a first distance DI out of the guiding slot. The arm pivot structure and the lower slot surface is substantially positioned within a sector of +/−20 degree from a line L perpendicular to the centerline S when the wheel and locking tool is in a locked position. More preferably the arm pivot structure and the lower slot surface is substantially positioned within a sector of +/−10 degree from a line L. Most preferably the arm pivot structure and the lower slot surface is substantially positioned along a line L perpendicular to the centerline S when the wheel and locking tool is in a locked position.

In an embodiment of the system each lever arm further comprises a jacking arm comprising an arm jacking surface interacting with a support jacking surface on the wheel support for moving the wheel a second distance D2 out of the wheel support.

In yet an embodiment of the system the pushing arm is configured to be clear of the support slot for further extraction of the guided structure out from the guiding slot when the locking tool has been rotated an angle α. Thus, allowing jacking the wheel a second distance D2 out of the wheel support by means of the arm jacking surface interacting with the support jacking surface on the wheel support.

In yet an embodiment of the system the support jacking surface is a surface substantially parallel to line L and positioned at least a distance D1 below the line L.

In yet an embodiment of the system a line K going through the arm pivot structure and a jacking surface on the jacking arm has a downward angle with the line L substantially equal to α when the locking tool is in the locked position.

In yet an embodiment of the system each arm comprises a rotation stopper surface to rest against a rest surface on the support once the wheel is in a locked position,

In yet an embodiment of the system a line M going through the pivot structure and the upper pushing arm surface, substantially, has an upward angle β smaller than α.

In yet an embodiment of the system the locking tool comprises tool holding means for holding the locking tool in position during use of the wheel.

In yet an embodiment of the system the holding means comprises a retainment structure on one of the lever arms interacting with a retainer slot on the wheel support

In yet an embodiment of the system the holding means comprises a knob on the gripping bridge interacting with a resilient arm on the wheel support.

In an embodiment of the system the wheel is a mecanum wheel.

### BRIEF DESCRIPTION OF FIGURES

The invention will now be described in more detail by reference to the accompanying figures. The same numeral on different drawings refer to the same feature.

FIG. 1 shows a perspective view of a mecanum wheel mounted on a wheel support using a system according to the invention.

FIG. 2 shows a locking tool positioned on a mecanum wheel.

FIG. 3 shows an exploded sectional view of an embodiment of the system according to the invention.

FIG. 4 shows an embodiment of the locking tool.

FIG. 5 shows an embodiment of a guided structure and a pivot structure on a mecanum wheel.

FIG. 6a shows a first stage of mounting the mecanum wheel to the wheel support.

FIG. b-c shows further stages of entering the guided structure of the wheel to the guiding slot of the wheel support.

FIG. 6d shows the mecanum wheel mounted to the wheel support

FIG. 7a and b shows embodiments of the locking tool.

FIG. 8a-c shows stepwise release of the wheel from the wheel support.

### DETAILED DESCRIPTION

We describe a wheel 1 and a wheel support 2 and the system according to the invention as it appears during normal use, that is standing on the floor/ground with the wheel 1 inserted/mounted in the wheel support 2 in a locked position.

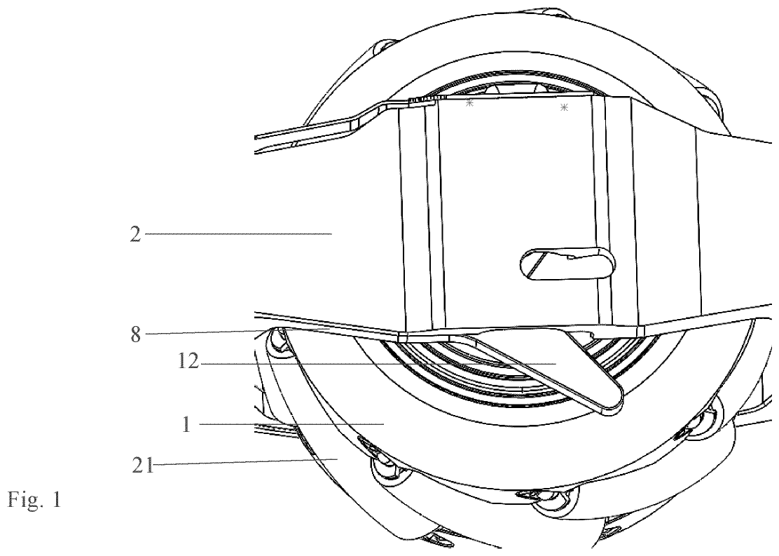

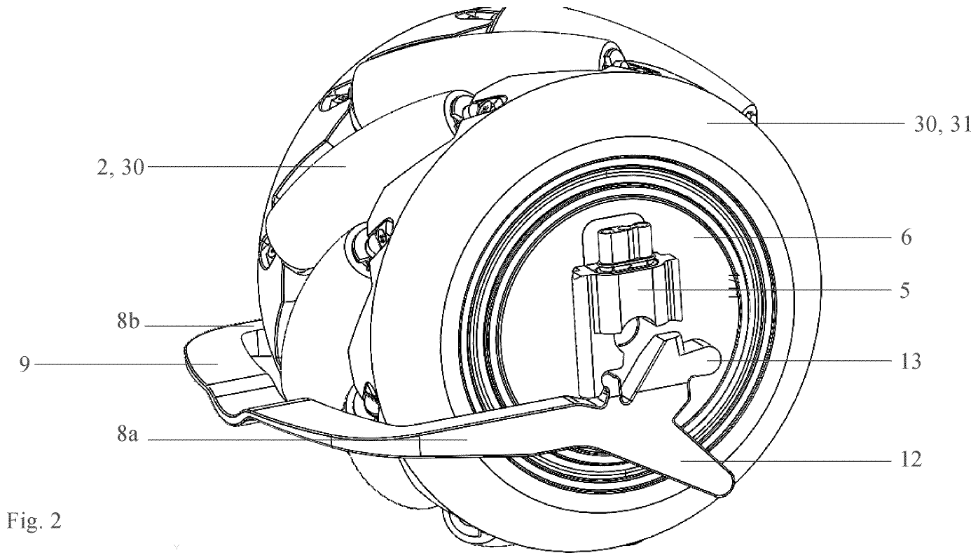

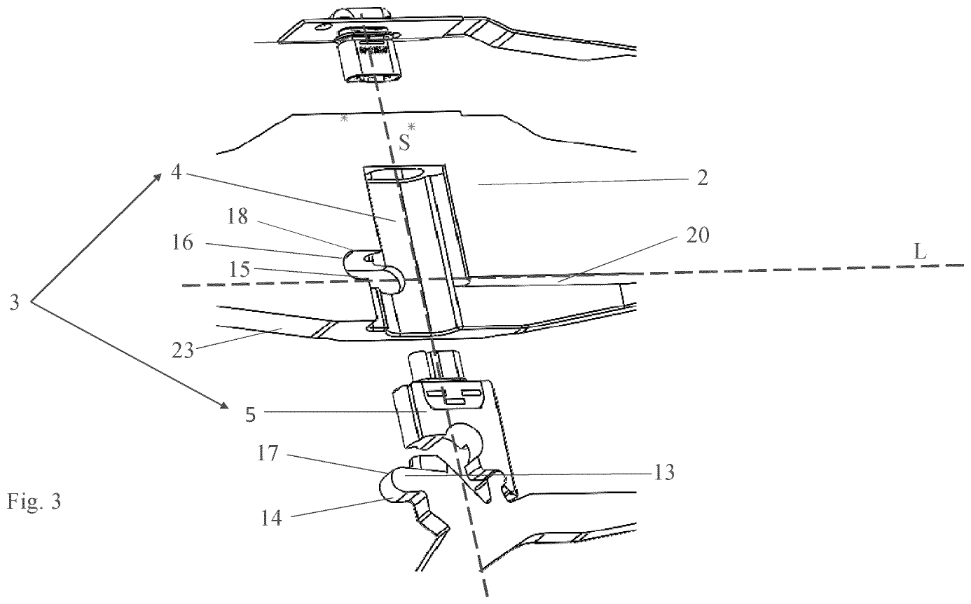

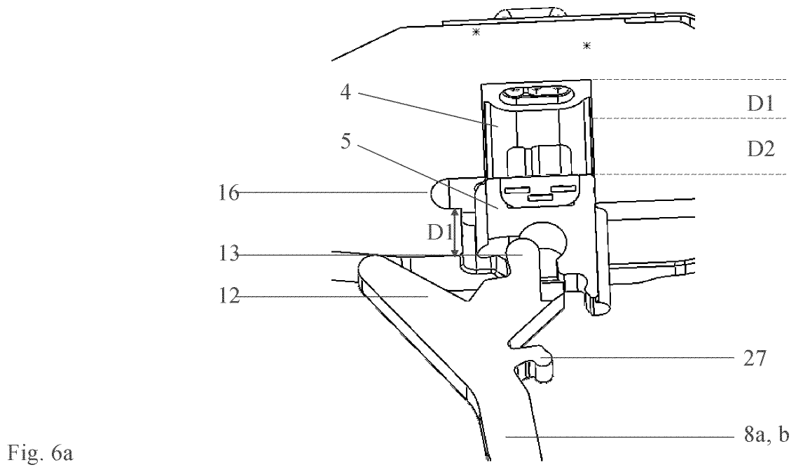

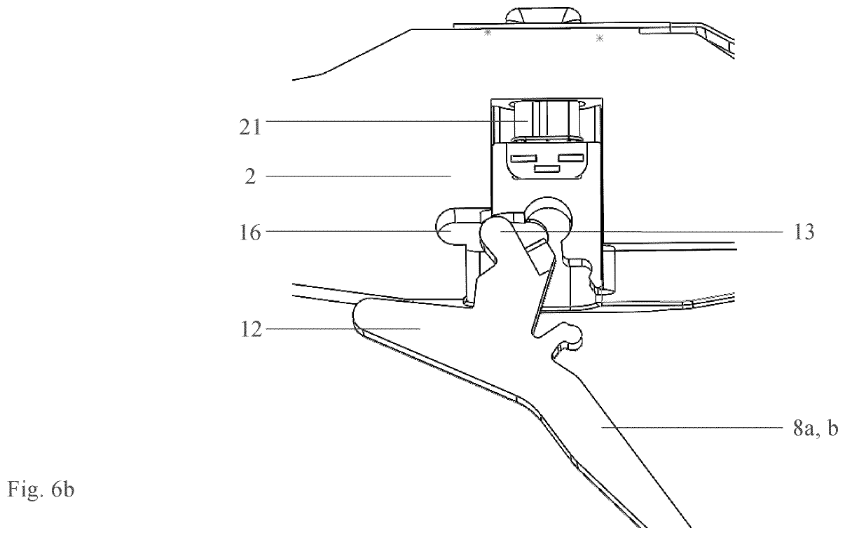

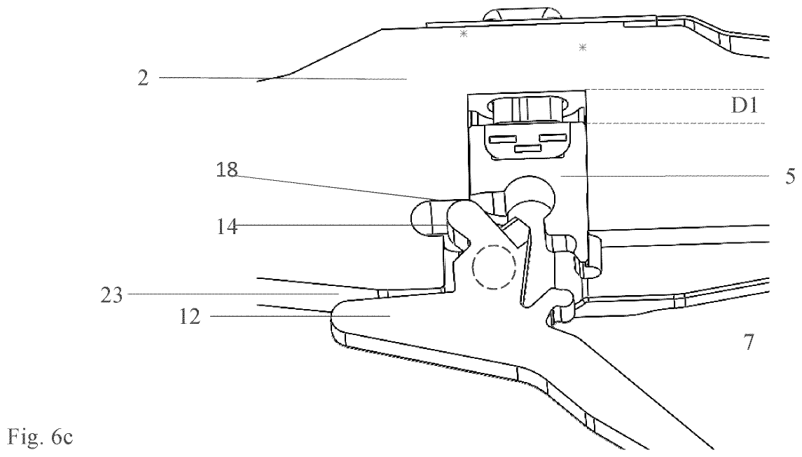

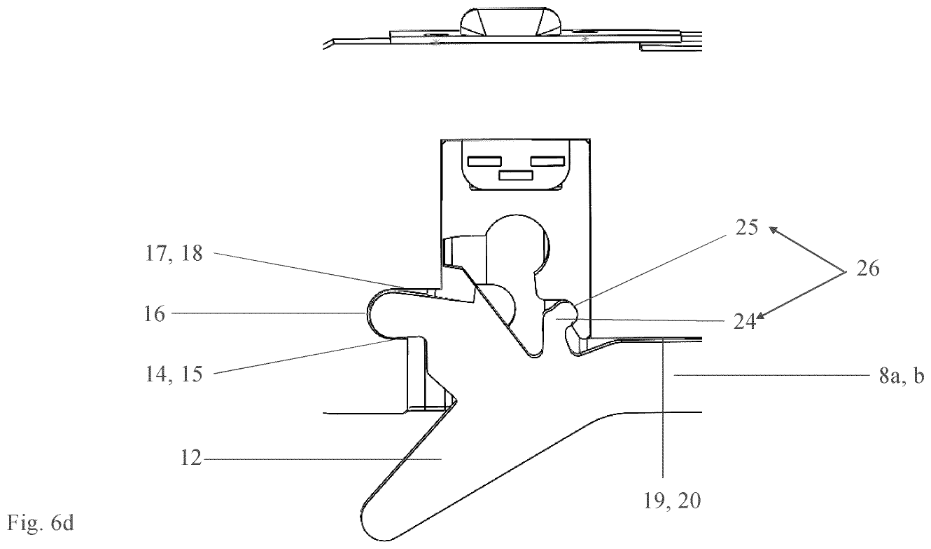

The invention describes a system for locking and releasing a wheel 1 to and from a wheel support 2. The invention is most useful for mecanum wheels because service intervals are shorter than for most wheels and replacement of mecanum wheels are frequent. In particular the rollers 21, as previously described in the Background-section, need to be replaced. A mecanum wheel with a locking tool according to the invention is seen in FIGS. 1 and 2. Rollers 21 are positioned around a circumference 20 of the wheel at an angle to a wheel plane, preferably of about 45 degrees. The system, as shown in FIGS. 3 and 6a, comprises an interlocking mechanism 3 comprising a guiding slot 4 positioned on the wheel support 2, see FIG. 3, and a guided structure 5 positioned on a stationary wheel section 6, see FIG. 2. The wheel comprises a stationary wheel section 6 and a rotational wheel section 30 rotating around the stationary wheel section 6. In the case of a mecanum wheel the rotational wheel section will comprise the rollers and a frame 31 on which the rollers 21 are mounted. The guiding slot 4 and the guided structure 5 mates with each other and holds the wheel in a fixed position relative to the wheel support 2. All forces acting on the wheel 1 and the wheel support 2 is handled by the interlocking mechanism 3. Referring to FIG. 3 the guiding slot 4 and the guided structure 5 have a common centerline S, along which the guided structure 5 move when entering into the guiding slot 4 on the wheel support 2, mating with the guiding slot 4.

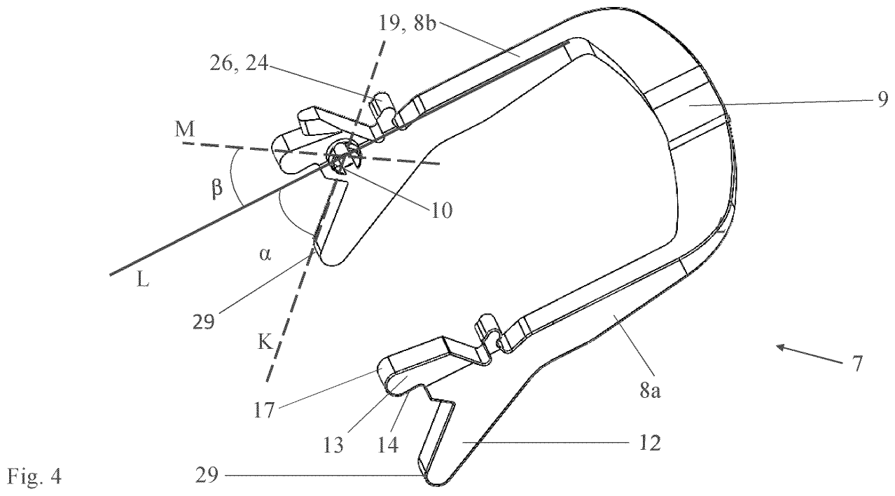

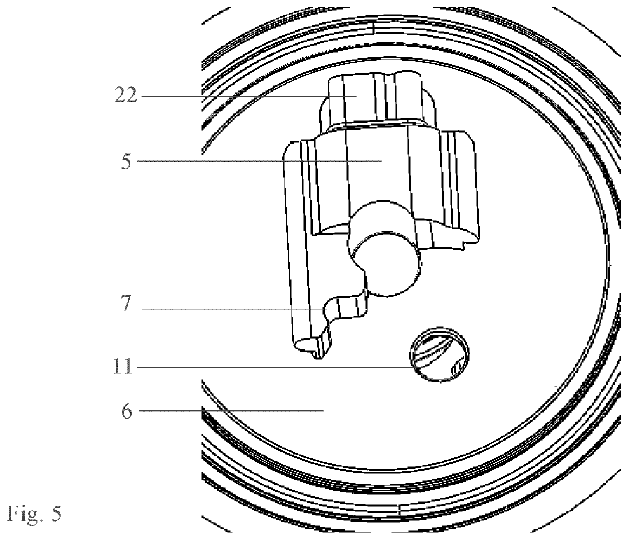

FIG. 4 shows a locking tool 7 comprising two lever arms 8a, b joined by a gripping bridge 9 at one end. At the other end of each lever arm 8a, 8b (not joined to the gripping bridge 9), an arm pivot structure 10 is provided. The arm pivot structure 10 interacts with a wheel pivot structure 11 positioned on the stationary wheel section 6 below the guided structure 5, see FIG. 5. The gripping bridge 9 and the two lever arms, 8a and 8b, of the locking tool 7 describes a U-shape that fits around the wheel it is arranged to lock and release.

At the end of each lever arm 8a, 8b (not joined to the gripping bridge 9) a pushing arm 13 is further provided as seen in FIG. 4. The pushing arm 13 comprises a lower pushing arm surface 14 interacting with a lower slot surface 15 in a support slot 16 in the wheel support 2 for pushing the guided structure 5 into the guiding slot 4, as seen in FIG. 3. The pushing arm 13 further comprises an upper pushing arm surface 17 interacting with an upper slot surface 18 in the support slot 16 for pushing the guiding structure 5 out of the guiding slot 4 a first distance D1, seen in 6a. The support slot 16 and associated surfaces are shown in FIG. 6d.

The arm pivot structure 10 and the lower slot surface 15 is positioned along a line L within a sector of +/−20 degree of perpendicular to the centerline S when the wheel is in the locked position. More preferably the arm pivot structure 10 and the lower slot surface 15 is positioned along a line L within a sector of +/−10 degree of perpendicular to the centerline S when the wheel is in the locked position. Most preferably, the arm pivot structure 10 and the lower slot surface 15 is positioned along a line L perpendicular to the center line S when the wheel is in the locked position. All force needed for the guided structure 5 to enter the final first distance DI (see FIG. 6c) into the guiding slot 4 is provided by the locking tool.

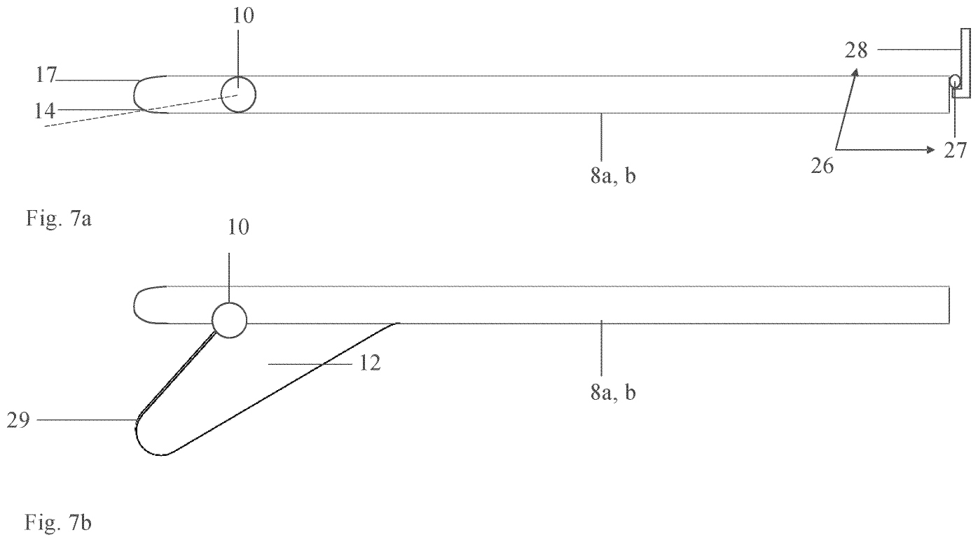

In an embodiments seen in FIG. 4 and FIG. 7b each lever arm 8a, b further comprises a jacking arm 12 comprising an arm jacking surface 29 interacting with a support jacking surface 23 on the wheel support 2 for moving the wheel 1 a second distance D2 out of the wheel support 2, as seen in FIG. 6a.

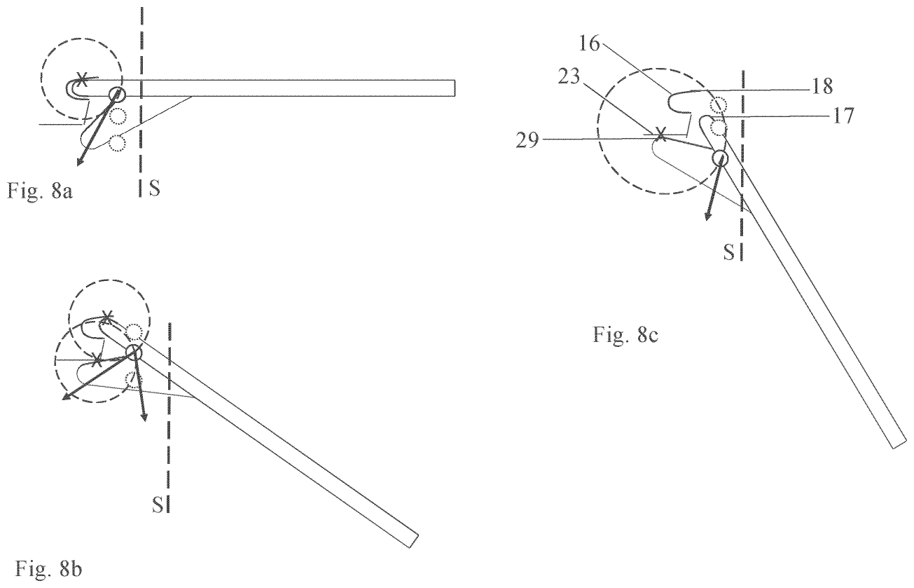

When the locking tool 7 is connected to the wheel 1 by means of the pivot structures 10, 11 and the operator pushes the lever arms 8a, 8b in order to take the wheel off, the pivot structures will initially try to describe a circular movement centered around a contact point X, marked in FIG. 8a-c as dotted circles. The contact is taking place between the upper pushing arm surface 17 and the upper slot surface 18 or an arm jacking surface 29 on a jacking arm 12 and the support jacking surface 23. The force acting on the pivot structures during removal of the wheel from the wheel support 2 is indicated with arrows in FIG. 8a-c. This circular movement must be transferred to a linear movement of the wheel causing the guided structure 4 to slide linearly out from the guiding slot 5 along the center line S. This is achieved by providing a support slot 16 which is as deep as the reach of the pushing arm when the locking tool is positioned with the arm pivot structure 10 interacting with the support pivot structure 11. This will allow the pushing arm 13 to slide in and out of the support slot 16 when the wheel and guided structure slide linearly along the centerline S. The arm jacking surface 29 of the jacking arm 12 is arranged to slide freely along the support jacking surface 23 when the locking tool is rotated. Also, the upper pushing arm surface 17 and the lower pushing arm surface 14 must be able to slide freely on their respective interacting surfaces. The sliding of the mentioned surfaces allows the circular movement of the pivot structures to be transformed to a linear movement of the guided structure 4 along the centerline S.

Preferably the lower slot surface 15 is slightly further away from the center line S than the upper slot surface 18. This is to allow the pushing arm 13 to enter into the support slot 16 at an early stage as the guided structure 5 of the wheel is entering the guiding slot 4. This also allows the pushing arm 13 to move unhindered past the support slot 16 as the jacking arm engages the support jacking surface and moves the guided structure 4 out of the guiding slot 5.

As previously stated, the pivot structure 10 and the lower slot surface 15 is substantially positioned along a line L perpendicular to the centerline S when the wheel is in the locked position. However, the deviation from this can be as big as maybe 20 degree and the locking tool would probably still function. The point is that when the guided structure 5 is pushed into the guiding structure 4 the final distance the resistance and friction reach a maximum and a force directed parallel with the centerline S is advantageous. Any deviation from this will increase the friction.

In most cases the wheel and wheel support will be upside down or maybe sideways when the wheel is locked into and released from the wheel support. FIG. 6a-6d shows mounting of a wheel by means of a locking tool 7 having a jacking arm 12 comprising an arm jacking surface 26 interacting with a support jacking surface 23 for jacking the wheel 1 out of the wheel support 2. The jacking arm also guide the pushing arm into the support slot 16 during mounting of the wheel.

FIG. 6a shows the guided structure 5 entering into the guiding slot 4. As the guided structure 5 enters the guiding slot 5 the jacking arm 12, if present, touches the support jacking surface 23 and as the guided structure 5 is pushed further into the guiding slot 4, the locking tool 7 starts to rotate due to the interaction between the jacking arm 12 and the support jacking surface 23 as can be seen in FIG. 6b. If the jacking arm is not present the lever arms 8a, b must be manually guided into position.

In FIG. 6c the rotational movement of the locking tool has brought the pushing arm 13 to a position just outside of the support slot 16. In this position the final distance of the guided structure 5 entering the guiding slot 16 can be carried out by the operator (or robot) pushing the locking tool 7 by the gripping bridge 9 and thus bringing the wheel 1 to a locked position in the wheel support 2 as can be seen in FIG. 6d.

The release of the wheel can be illustrated by the same FIGS. 6a-d in reverse order. Starting with FIG. 6d the operator (or robot) start pushing the locking tool downwards and the upper pushing arm surface 17 is pushed towards the upper slot surface 18 of the support slot and the guided structure 5 is pulled out from the guiding slot 4 a first distance D1 until the upper pushing arm surface 17 leaves the upper slot surface 18 of the support slot 16 as can be seen in FIG. 6c. In this position the jacking arm 12 approaches or engages the support jacking surface 23 and interaction between these two surfaces will lift the wheel a second distance D2 out of the wheel support 2 as seen in FIGS. 6b and 6a.

When mounting the wheel in the wheel support it is easy to push the wheel in place, but when removing the wheel from the wheel support it is difficult to get a grip on the wheel because it is hidden inside the wheel support and possibly a chassis or cover preventing dust to enter moving parts. Therefore, the locking tool provides one levered movement during mounting/locking of the wheel (corresponding to D1 in FIG. 6c) and two levered movements during release of the wheel from the wheel support 2 (corresponding to D1 and D2 in FIG. 6a).

Preferably the pushing arm 13 is shorter than the jacking arm 12 in order to provide extra force in the initial phase of removing the wheel 1 from the wheel support 2 and in the final phase of mounting the wheel. Preferably the length of the pushing arm is between ¼ and 1/10 of the length of the lever arms 8a, b and the length of the jacking arm is between ½ and ⅕ of the length of the lever arms 8a, b. All lengths are measured from the center of the arm pivot structure 10 to the end of the respective arms.

In an embodiment the locking tool comprises tool holding means 26 for holding the locking tool in position during use of the wheel. FIG. 6d shows an embodiment where the holding means 26 comprises a resilient retainer structure 24 on the lever arms 8a, 8b interacting with a retainer slot 25 in the wheel support 2. In FIG. 7a a knob 27 fastened to the end of the lever arm or to the gripping bridge is interacting with a resilient arm 28 fastened to the wheel support 2.

FIG. 4 pertains to embodiments comprising a jacking arm 12 and shows a line K going through the arm pivot structure 10 and the arm jacking surface 29 on the jacking arm. The line K has substantially a downward angle α with the line L. FIG. 4 also shows a line M going through the pivot structure and the upper pushing arm surface 17. Line M has substantially an upward angle β that is smaller than α. This configuration allows the pushing arm to retract the guided structure 5 from the guiding structure 4 a first distance D1 as seen in FIG. 6c and then the jacking arm 12 will retract the guided structure the rest of the distance (a distance D2). The pushing arm is configured to retract from the support slot 16 when the lever arms 8a, b have rotated the angle α from the locked position. The upward angle β of the line M will cause the pushing arm to move towards the centerline S during initial rotation of the locking tool 7. In this position the arm jacking surface 29 of the jacking arm 12 is configured to touch the support jacking surface 23 of the wheel support 2 and start further retraction of the wheel 1 from the wheel support 2, which corresponds to the retraction of the guided structure 5 from the guiding slot 4.

Preferably the support jacking surface 23 is a surface substantially parallel to line L and positioned at least a distance DI below the line L as seen in FIG. 4. This will cause the pull of the lever arm 8a, b to be relatively parallel to the centerline S. Worded differently; when the jacking arm is active for extracting the guided structure from the guiding slot 5 a second distance D2, the rotational sector described by the locking tool contains a line parallel to the line L.

FIG. 7a shows a simple version of the locking tool without a jacking arm 12. In this embodiment the deviation of the position of the lower pushing arm surface from the line L perpendicular to the centerline S is roughly 10 degrees as indicated by the dotted line.

FIG. 7b shows a simple version with a jacking arm 12. In this embodiment the position of the lower pushing arm surface is on the line L.

### REFERENCES

1 Wheel
2 Wheel support
3 Interlocking mechanism
4 Guiding slot
5 Guided structure
6 Stationary section of wheel
7 Locking tool
8a and b Lever arms
9 Gripping bridge
10 Arm pivot structure
11 Wheel pivot structure
12 Jacking arm
13 Pushing arm
14 Lower pushing arm surface
15 Lower slot surface
16 Support slot
17 Upper pushing arm surface
18 Upper slot surface
19 Rotation stopper surface
20 Rest surface
21 Roller
22 Electrical contact
23 Support jacking surface
24 Retainer structure
25 Retainer slot
26 Tool holding means
27 Knob
28 Resilient arm
29 Arm jacking surface
30 Rotational wheel section
31 Wheel frame

1. A system for locking and releasing a wheel (1) to and from a wheel support (2), the system comprising:
an interlocking mechanism (3) comprising:
a guiding slot (4), with a centerline(S), on the wheel support (2), and
a guided structure (5), positioned on a stationary wheel section (6) of the wheel (1), configured for mating with the guiding slot (4),
characterized by a locking tool (7) comprising two lever arms (8a, b) joined by a gripping bridge (9) at one end, wherein each lever arm, at the other end, comprises:
an arm pivot structure (10) interacting with a wheel pivot structure (11) positioned on the stationary wheel section (6) below the guided structure (5),
a pushing arm (13) comprising:
a lower pushing arm surface (14) interacting with a lower slot surface (15) in a support slot (16) in the wheel support (2) for pushing the guided structure (5) into the guiding slot (4), and
an upper pushing arm surface (17) interacting with an upper slot surface (18) in the support slot (16) for pushing the guided structure (5) a first distance (D1) out of the guiding slot (4),
wherein the arm pivot structure (10) and the lower slot surface (15) is substantially positioned along a line (L) perpendicular to the centerline(S) when the wheel and locking tool (7) is in a locked position.

2. System according to claim 1 wherein each lever arm (8a, b) further comprises a jacking arm (12) comprising an arm jacking surface (29) interacting with a support jacking surface (23) on the wheel support (2) for moving the wheel (1) a second distance (D2) out of the wheel support (2).

3. System according to claim 2, wherein when the locking tool has been rotated an angle α, the pushing arm (13) is configured to be clear of the support slot (16) allowing further extraction of the guided slot (4) out from the guiding structure by means of the arm jacking surface (29) interacting with the support jacking surface (23).

4. System according to claim 3, wherein the support jacking surface (23) is a surface substantially parallel to the line (L) and positioned substantially a distance equal to the first distance (D1) below the line (L).

5. System according to claim 2, wherein a line (K) going through the arm pivot structure (10) and the arm jacking surface (29) on the jacking arm (12), substantially, has a downward angle with the line (L) equal to α when the locking tool (7) is in a locked position.

6. System according to claim 2, wherein each arm (8a, b) comprises a rotation stopper surface (19) to rest against a rest surface (20) on the wheel support (2) once the wheel (1) is in a locked position.

7. System according to claim 5, wherein a line (M) going through the arm pivot structure (10) and the upper pushing arm surface (17), substantially, has an upward angle β smaller than α.

8. System according to claim 1, wherein the locking tool (7) comprises tool holding means (26) for holding the locking tool (7) in position during use of the wheel.

9. System according to claim 8, wherein the holding means comprises a retainment structure (24) on one of the lever arms (8a, b) interacting with a retainer slot (25) on the wheel support.

10. System according to claim 8, wherein the holding means comprises a knob (27) on the gripping bridge (9) interacting with a resilient arm (28) on the wheel support (2).

11. System according to claim 1, wherein the wheel (1) is a mecanum wheel (1).
